(19) United States
(12) Patent Application Publication
(10) Pub. No.: US 2019/0196045 A1
(43) Pub. Date: Jun. 27, 2019

(54) Method and apparatus for marine electrical exploration

(71) Applicant: ORG GEO AS, Randaberg (NO)

(72) Inventors: Eirik Grude Flekkoy, Nesoddtangen (NO); Endre Berntsen Haland, Lindesnes (NO); Martin Springer, Trondheim (NO); Geir R. Drivenes, Kleppe (NO); Jostein Kare Kjerstad, Stavanger (NO)

(21) Appl. No.: 15/768,014

(22) PCT Filed: Aug. 29, 2016
(86) PCT No.: PCT/EP2016/070304

§ 371 Date: Apr. 13, 2018

(30) Foreign Application Priority Data
Oct. 15, 2015 (EP) 15189977.0

(51) Int. Cl. G01V 3/08; G01V 3/12; G01V 3/15

(52) U.S. Cl. CPC G01V 3/083; G01V 3/12; G01V 2003/085; G01V 2003/086; G01V 3/15

(57) ABSTRACT

A method and apparatus for offshore electromagnetic surveying for the purpose of hydrocarbon exploration and detection is described. The method comprises the step of A) measuring a measurement vector u between receiver electrodes, where the measurement vector u comprises a plurality of measurement signals uᵢ, being dependent on a geological characteristic mₖ at an geological parameter index k providing information about the geological structure of the geological target area. The method is further characterized in that it also comprises the following steps: B) calculating a transformed vector v as a function of the measurement vector u, where said transformed vector v is designed to optimize the sensitivity to changes in the geological characteristic mₖ and C) performing, for each time t, at least one of minimizing uncertainty δv(k,t) of the transformed vector v with respect to the geological characteristic mₖ, where said uncertainty δv(k,t) comprises a non-systematic uncertainty δv′(k,t) and a systematic uncertainty Δ_{wd}v(k,t), maximizing a target response ∂v(k,t)/∂mₖ of the transformed vector v with respect to the geological characteristic mₖ and minimizing a ratio ψ(k,t) between at least the square of the non-systematic uncertainty <δv′(k,t)²> of the transformed vector v and the square of the target response (∂v(k,t)/∂mₖ)² of the transformed vector v with respect to the geological characteristic mₖ.

### TECHNICAL FIELD

The present invention relates to a method and apparatus for marine electrical exploration as defined in the introductory part of the independent claims.

### BACKGROUND AND PRIOR ART

The main characteristics of the method are that it identifies hydrocarbon deposits through the way they alter the geochemistry and electrical response of the overburden. Due to the flexibility of the multipole nature of the transmitters and receivers, the main advantages of the method are that it
1. Optimizes contrasts in measured data caused by the presence of hydrocarbons by adjusting the combination of measured voltage differences and other data.
2. Minimizes equivalence in the data-inversion between geo-electrical parameters. This is done both by means of data processing and adjustment of the transmitter and receiver characteristics.

The basis for the technology is the observation that no caprock over any reservoir is entirely impermeable. Consequently, some micro-seepage will exist, causing mineralogical changes in the overburden, i.e. at much shallower depths than the reservoir itself. This means that a reasonably light and mobile system may be employed to detect the electrical response to such changes, which will include pyrite formation, giving rise to Induced Polarization (IP) responses, magnetite or maghemite, which will give rise to contrasts in magnetizability, and direct changes in sea-bottom chemistry, in particular the presence of various hydrocarbons. Also the changes in mineralogy will cause stationary currents surrounding the reservoir volume.

Electric Fields from Controlled Source

The basis for the modelling is given in the following. When Ohms law becomes history dependent the diffusion equation too takes a history dependent form. By taking the Fourier time-transform of Maxwells equation ∇×B=μ₀(j+ε₀∂E/∂t), dropping the displacement current ε₀∂E/∂t as usual, the diffusion equation is generalized to

iωj(x,ω)=D(ω)(∇²j(x,ω)+∇×∇×j^{e}(x,ω)) (1)

where jₑ is the source current and the electric field that we measure is given by

$$E ( ω ) = \frac{j ( ω )}{σ ( ω )} \qquad ( 2 )$$

In the above

$$D ( ω ) = \frac{1}{μσ ( ω )} \qquad ( 3 )$$

In the time domain,

$$\frac{\partial j}{\partial t} = {\int }_{- ∞}^{t} {dt}^{′} D ( t - {t}^{′} ) ( {∇}^{2} j ( x , {t}^{′} ) + ∇ \times ∇ \times {j}^{e} ( x , {t}^{′} ) ) \qquad ( 4 )$$

The conductivity is represented by the Cole-Cole [1] relation and has the form

$$σ ( ω ) = {σ}_{∞} ( 1 - \frac{η}{1 + {( i ωτ )}^{c}} ) \qquad ( 5 )$$

The solution of the above equations may be done by standard procedures, either using a 1D, 2D or 3D model of the earth, and provides the basis for inversion using the novel techniques of the present invention, as will be explained below. This will give the resistivity and the chargeability η(x) as a result,

Magnetic Background Field Deviations

As noted in studies dating back to the sixties, see [8] for a brief review, the reducing- or other mineralogical effects above a reservoir causes anomalies in the magnetic susceptibility. In the comprehensive study of [8] the mineral that was largely responsible for the anomalies was maghemite. The magnitude of the anomalies measured directly in drill cuttings is of the order

χ˜(1−2)10⁻⁴ (6)

where the dimensionless susceptibility is given via the magnetization, or magnetic moment per unit volume m=χB. Writing the magnetic field in terms of the stationary background field B₀ and a vector potential as

B=∇×A+B₀, (7)

the above Maxwell equation takes the form

∇×(∇×A−m)=μ₀j=0, (8)

where we have used the assumption that there are no free currents, or, in other words, that any sources have been switched off sufficiently long. Choosing the Coulomb gauge condition ∇·A=0, which we are always free to do, we get the Poisson equation

−∇²A=∇×m, (9)

or, since m=χB≈χB₀,

∇²A=B₀×∇_{χ}. (10)

Using the Green function for the Laplace operator, that satisfies

∇²G(r)=δ³(r) (11)

we can write the solution for the Poisson equation

A=∫d³r′G(r−r′)B₀×∇′χ(r′). (12)

This allows us to model the magnetic field using standard formulae for the perturbations caused by 3D variations in the earth.

Static Potential Measurements

It is well known that around and above a hydrocarbon reservoir the mineralogical and chemical changes will give rise to gradients in the electrochemical potential on the same scale as the reservoir itself. The induced potential differences caused by the gradients will give rise to static electric fields that may be recorded by the same equipment that is used to record the responses to any transmitted electric field from the controlled sources. These static electric fields may be modelled very much like the static B-field changes and applied, along with other techniques, to detect reservoir edges or prospect boundaries.

Prior Art

Conrad Schlumberger [10] investigated the IP effect (IP=induced polarization) for electrical surveying and observed that small offset distance and large delay time are favoring the IP/EM signal ratio (EM=electromagnetic). Early methods to measure IP-effects include geo-electric prospecting methods used to determine rock polarizability. These methods applied the time and the frequency domain. For time-domain applications, see [4]. The FS-IP method in [5] exemplifies frequency domain applications.

Differential measurements, where differences of potential differences ΔU₁−ΔU₂ are calculated to estimate field gradients, are well known as input to IP inversion algorithms, see [7] and [2] and references therein. Such geophysical techniques are therefore established and free technologies.

In a recent patent application [6], IP-measurements are proposed using electric fields resulting from a bipole source. The measured fields are normalized by their initial values, and these normalized parameters are then combined in various parameters for inversion. This is done to achieve a partial noise cancellation and increased sensitivity to desired geological target quantities during the inversion. This is also the case in a recent work where the phase of the complex valued signal and its measured noise is singled out in the inversion process [9]. However, there is no procedure in these methods and approaches to obtain an optimized combination of data which is adapted to the actual data and noise-measurements at hand.

There is thus a need to further enhance the sensitivity/contrast of the geological target. Such enhancement may be obtained by improving the analysis, or data processing. Alternatively, the enhanced sensitivity of the measured data to a given geological target may be obtained by optimizing the transmitter currents and/or the transmitter electrode configuration.

### SUMMARY OF THE INVENTION

The present invention is set forth and characterized in the main claims, while the dependent claims describe other characteristics of the invention.

In particular, the invention concerns a method suitable for measuring and analyzing measurement data from an electromagnetic survey of a geological target area that potentially contains a hydrocarbon reservoir. The method comprises the step of

A) measuring a measurement vector u between at least two receiver electrodes, said measurement vector u comprising a plurality of measurement signals uᵢ. The receiver electrodes may be situated along at least one towing cable used in the electromagnetic survey, for example behind a vessel. However, the receiver electrodes may also be arranged on other objects such as underneath a floating board. i is an integer that may index position and/or time during the survey and has a range between 1 and N, where N equals the total number of measurement points. At least one of the plurality of measurement signals uᵢ is dependent on a geological characteristic mₖ. Said geological characteristic mₖ provides information about the geological structure of the geological target area and may for example be an electrical property of the geology such as electrical resistivity ρ, chargeability η, Cole-Cole exponent c, or any combination thereof. mₖ may also be a chemical property such as a concentration of a chemical substance Cᵢ. k is an geological parameter index keeping track on the various geological characteristics {mₖ}, if more than one are of interest in the survey.

The method is further characterized in that it comprises the additional step of: B) calculating a transformed vector v as a function of the measurement vector u, where each component v(k,t) of the transformed vector v at a geological parameter with index k and a time t is calculated by projecting the measurement vector u in the direction given by a unit vector e(k,t), that is, performing the operation v(k,t)=e(k,t) u(t). The unit vector e(k,t) is governed by the geological characteristic mₖ. The transformed vector v is designed to optimize the sensitivity to changes in the geological characteristic mₖ by performing, for each time t, at least one of minimizing uncertainty δv(k,t) of the transformed vector v with respect to the geological characteristic mₖ, where said uncertainty δv(k,t) comprises a non-systematic uncertainty δv′(k,t) and a systematic uncertainty Δ_{d}v(k,t), maximizing a target response δv(k,t)/δmₖ of the transformed vector v with respect to the geological characteristic mₖ and minimizing a ratio ψ(k,t) between at least the square of the non-systematic uncertainty <δv′(k,t)²> of the transformed vector v and the square of the target response (∂v(k,t)/∂mₖ)² of the transformed vector v with respect to the geological characteristic mₖ,

that is minimizing:

$$ψ ( k , t ) = \frac{〈 δ {{v}^{′} ( k , t )}^{2} 〉}{{( \partial v ( k , t ) / \partial {m}_{k} )}^{2}} . \qquad ( 13 )$$

The unit vector e(k,t) is governed by the geological characteristic mₖ and may vary in time. Hence, the minimizing and/or maximizing operations mentioned above could in this particular embodiment be an optimization with respect of e(k,t).

As an alternative or addition to the latter step one may add square of the systematic uncertainty Δ_{wd}v(k,t) to the square of the non-systematic uncertainty δv(k,t) prior to completing the minimizing step of ratio ψ(k,t), that is minimizing:

$$ψ ( k , t ) = \frac{〈 δ {{v}^{′} ( k , t )}^{2} 〉 + {( {Δ}_{wd} v ( k , t ) )}^{2}}{{( \partial v ( k , t ) / \partial {m}_{k} )}^{2}} \qquad ( 14 )$$

Systematic uncertainty Δ_{wd}v(k,t) may for example include uncertainties in water depth variations

Note that the measurement signals uᵢ might have been subjected to one or more processing steps prior to step B, for example in order to reduce unwanted drift and other noise contributions. In that case the measurement positions i may be in the form of a plurality of spatial bins N_{B}, where each bin represent an average over a plurality of discrete positions. With N_{T} different discrete time values or bins t, one obtain a total number of measurement points N=N_{B}N_{T}. Hereinafter time t may represent either a continuous time t or a discrete time bin t, depending on whether or not the above mentioned processing steps have been carried out.

In an advantageous embodiment the step of minimizing the uncertainty δv(k,t) of the transformed vector v with respect to the at least one geological characteristic mₖ is performed using an equation defined as

$$〈 δ v ( k , t ) 〉 = \sqrt{( 〈 δ {{v}^{′} ( k , t 〉}^{2} ) + {( {Δ}_{wd} v ( k , t ) )}^{2}} = \sqrt{\frac{1}{{N}_{B}} {\sum }_{i = 1}^{{N}_{B}} {( {v}^{i} ( k , t ) - \overline{v} ( k , t ) )}^{2} + {( v ( k , h + Δ h , t ) - v ( k , h , t ) )}^{2}} \qquad ( 15 )$$

where N_{B} is the number of spatial bins along a measurement line, which spatial bin size corresponds to the geological scale of interest, i is an integer number indexing each spatial bin, vⁱ(k,t) is the value of the transformed vector v at spatial bin i, index k and time t, v̅(k,t) is an average over consecutive sequences (stacked average) of the response at index k and time t, h is a parameter that generates a systematic error in the transformed vector v, and v(k,h,t) and v(k,h+Δh,t) are calculated components of the transformed vector v for the systematic errors h and h+Δh, respectively, at a geological parameter index k and a time t. Note that the systematic error may be zero, or not significant. A typical size of a spatial bin may lie in the range 0.5-10 kilometers, for example 1 kilometer.

In another advantageous embodiment the step of maximizing the target response ∂(k,t)/∂mₖ of the transformed vector v with respect to the geological characteristic mₖ is performed using an equation defined as

$$\frac{\partial v ( k , t )}{\partial {m}_{k}} \approx \frac{v ( k , {m}_{k} + Δ {m}_{k} , t ) - v ( k , {m}_{k} , t )}{Δ {m}_{k}} \qquad ( 16 )$$

where Δmₖ is an increment of the geological characteristic mₖ and v(k,mₖ,t) and v(k, mₖ+Δmₖ,t) are calculated components of the transformed vector v for the geological characteristics mₖ and mₖ+Δmₖ, respectively, at a given geological parameter index k and a time or time bin t.

In another advantageous the optimizing step is carried out for a plurality of k values corresponding to a plurality of geological characteristics {mₖ}, thereby enabling a subsequent identification of at least one direction of the transformed vector v that optimize sensitivity for a corresponding geological characteristic mₖ.

In another advantageous embodiment the method further comprises the step of minimizing an objective function defined as

$$φ = {\sum }_{k = 1}^{{N}^{″}} ( {\sum }_{t} \frac{{( {v}^{d} ( k , t ) - {v}^{m} ( k , t ) )}^{2}}{{( δ v ( k , t ) )}^{2}} ) \qquad ( 17 )$$

for example by using the well-known Levenberg-Marquart algorithm. In the equation 17 N″ is the total number of geological characteristics {mₖ} corresponding to said plurality of k values, v^{d}(k,t) is a value of the transformed vector v corresponding to the measurement signal uᵢ at geological parameter index k and time t, v^{m}(k,t) is a calculated value of the transformed vector v based on a geological characteristic mₖ corresponding to a predetermined model. This minimizing algorithm may provide the optimal direction of the unit vector e(k,t).

In another advantageous embodiment the method further comprises the step of measuring locations of said receiver electrodes, which, as mentioned above, may be situated along at least one towing cable. The step A and the step of measuring locations of said receiver electrodes are preferably performed simultaneously, or near simultaneously.

In another advantageous embodiment at least one of measurement signals uᵢ is a potential difference. Alternatively, or in addition, to the potential difference, one or more of measurement signals uᵢ may be an electrical field, a magnetic field or a static electrical potential.

In another advantageous embodiment at least one of the geological characteristic mₖ comprises a geochemical parameter such as hydrocarbon concentration in seabottom sample. Such geochemical parameter(s) may be in combination with the above mentioned geo-electric characteristic(s).

The invention also concerns an apparatus suitable for measuring and analyzing electromagnetic data over a geological target area that potentially contains a hydrocarbon reservoir. The apparatus comprises at least two receiver electrodes suitable for recording measurement signals ui from the geological target area and a computer program product stored on a computer usable medium comprising computer readable program means to control an execution of the method in accordance with any one of the above mentioned method steps and in any combinations. At least some of the plurality of receiver electrodes may be configured to measure at least one of a magnetic background field and a static electrical potential in order to complete step A) of the method.

In an advantageous embodiment the apparatus further comprises a towing system comprising a plurality of towing cables, where at least one towing cable comprises said at least two receiver electrodes and at least one towing cable comprises a plurality of transmitter (TX) electrodes, preferably at least three (TX) electrodes, wherein the transmitter (TX) electrodes are configured to broadcast electromagnetic signals to the geological target, preferably in the form of a plurality of current pulses with finite durations. Examples of current pulses with finite durations are pulses with rectangular or near rectangular waveforms, or any other waveforms with sharp/abrupt onsets and ends. For the finite pulse embodiment the at least one receiver electrode pair is further configured to record the measurement signals uᵢ at points in time between the transmitted plurality of current pulses. That is, the recordings are carried out during the pause between the current pulses. The waveforms are herein defined as having ‘sharp/abrupt onsets/ends’ term ‘if the onset and shut-off times are much shorter than the transmission and recording times for each pulse period. For example, a time duration of a raise or decrease in current from below 10% to above 80% of the maximum current within a pulse of less than 10% of the pulse’ full width at half maximum (FWHM) may be considered sharp/abrupt. The pause between the pulses is defined as the period of the pulse train where the current is less than 10% of the maximum current within a pulse.

In another advantageous embodiment the position of the plurality of transmitter (TX) electrodes and/or the transmitted current pulses from the plurality of transmitter (TX) electrodes is, by use of the above mentioned computer program product, adjusted iteratively during the recording of the measurement signals uᵢ in order to optimize sensitivity to at least one geological characteristic mₖ of a given geological target. Such an iterative adjustment may be carried out by forward calculations. The relative contrast relating to the introduction of a geological change (as for instance the introduction of a chargeable layer) is in this embodiment calculated using different configurations of transmitter (TX) currents and/or spatial distribution configurations of the plurality of transmitter electrodes. This is itself a well defined optimization problem that is solved either by a linear search in the space of parameters that specify the towing cables and the transmitter electrodes, or by established inversion algorithms or a combination thereof. The particular embodiment seeks to optimize the transmitter current combinations and can be done in addition to the subsequent analysis of the method (step B).

In another advantageous embodiment the at least one towing cable including the at least one receiver electrode comprises at least one of magnetometers suitable for measuring magnetic field, pressure sensors suitable for measuring pressure, transponders suitable for localizing the transmitter (TX) electrodes relative to a towing vessel, accelerometers suitable for measuring acceleration and gyroscopes suitable for measuring orientation. At least one of the above mentioned components may also be connected to at least one towing cable comprising the at least two transmitter electrode, for example the at least one accelerometer and/or the at least one gyroscope.

In another advantageous embodiment the apparatus further comprises a fiberoptic cable, for example attached to the at least one towing cable comprising the at least one receiver electrode. The fiberoptic cable is configured to enable monitoring of cable displacements between the plurality of towing cables during use.

In all of the above mentioned embodiments the measurement signals uᵢ may be induced in the geological target area by generating at least one electric field from at least one controllable electric field source within the transmitter system prior to step A).

As an alternative to use of towing cables, the at least two receiver electrodes of the apparatus may be arranged on any other object, preferably a buoyant object which enables the receiving electrodes to detect measurement values uᵢ during drift or propulsion of the buoyant object on water. An example of an object is a buoyant board, a vessel or a buoy. An example of relevant measurement values uᵢ is static potential.

The above mentioned method and apparatus exploits the possibility of optimizing the contrast in the measured data for presence of hydrocarbons by finding the parameters that shows the highest sensitivity to geological characteristics {mₖ}. Another aim of the present invention is to exploit the possibility of optimizing transmitter current combinations and transmitter electrode spatial distribution. The technology is designed to be sensitive to anomalies of induced polarization, quantified by such quantities as the chargeability, etc, while at the same time recording changes in the magnetic background field and/or electrostatic potentials.

In the following description, specific details are introduced to provide a thorough understanding of embodiments of the method and a marine electrical exploration system. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

### BRIEF DESCRIPTION OF THE DRAWING

FIG. 1 is a conceptual illustration of the towed system, showing N transmitter electrodes and M receiver electrodes attached to separate towing cables, where Δu₁ is the voltage difference between electrodes 1 and 2,

FIG. 2 is an one-dimensional geo-electric model and its associated geo-electrical parameters of a layered rock strata situated under a body of water and

FIGS. 3(a) and (b) show graphs of the initial potential difference parameter u₁ (a) and the transformed parameter v₅ as function of position along survey lines.

### DETAILED DESCRIPTION OF THE INVENTION

Transmission and Recording System

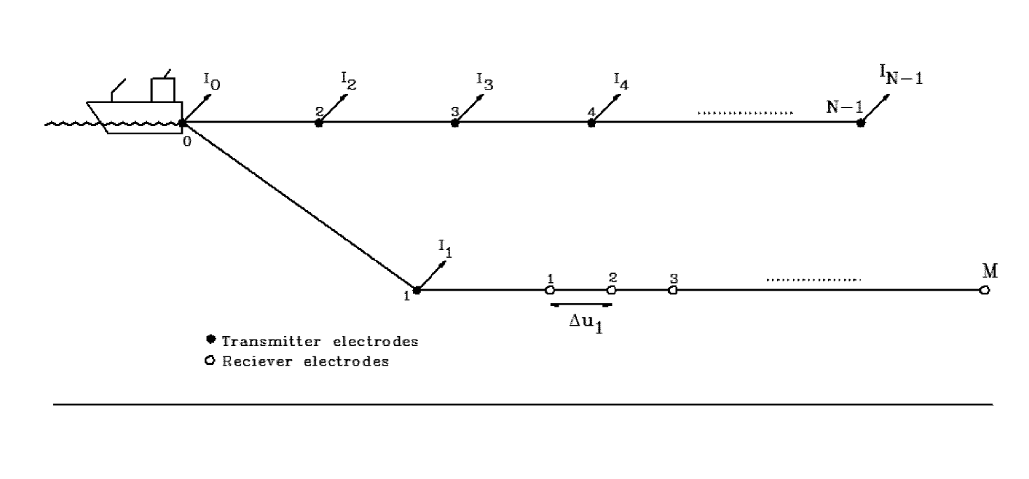

The principal layout of transmission and recording system of the present invention is illustrated in FIG. 1, showing towing cables with transmitter electrodes (i=0 . . . N−1) and receiver electrodes (i=1 . . . M). The currents flowing from the i electrode into the water are imposed individually. I.e. the current imposed between electrode 0 and 1 is denoted I₁, the current from electrode 1 to electrode 2 I₂, the current from electrode 1 to electrode 3 I₃, etc. The total current is thus Iₜₒₜ=ΣᵢIᵢ. Apart from the electrodes this system may include magnetometers, pressure sensors and transponders (not shown).

Generally, inversion of EM data is an exercise in data-fitting where a so-called objective function, or difference function, is minimized with respect to the geo-electrical parameters of the earth. These parameters typically include resistivity, and the objective function measures the difference between the recorded data and the corresponding calculated values that results from Maxwells equations and the geo-electric parameters.

When measuring IP effects by means of inversion of EM data, there is generally a significant equivalence between the values of different geo-electric parameters, such as local resistivity and charge values. This problem may be significantly reduced by combining signals which give complementary information on the subsurface. In particular, during a survey the relative strengths of the currents will be varied in order to reduce equivalence.

Data Treatment by Means of the Method of Optimized Parameters—MOPS

The inventive method, hereinafter referred to as the Method of Optimized Parameters—MOPS, is based on the idea that a set of measurement data should be combined and weighted in a way that maximizes the sensitivity to the target geological structure and minimizes the noise.

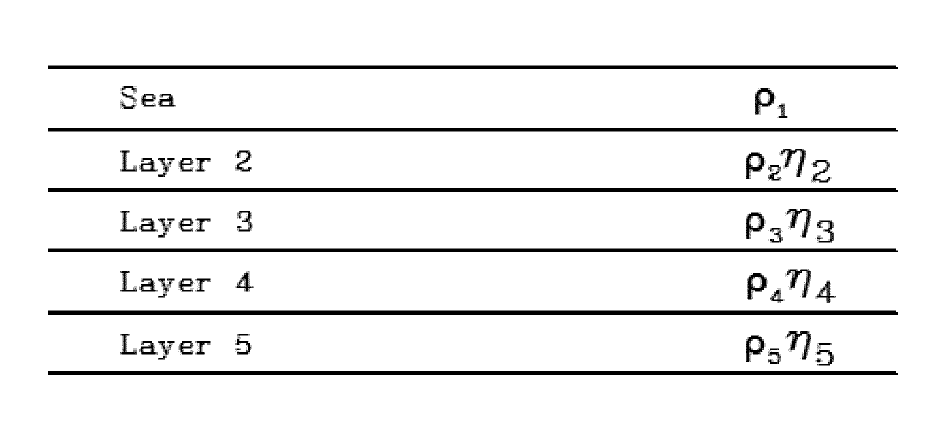

Normally inversion of the measured data is carried out to obtain the geo-electrical parameters that describe the target geological structure. These parameters may be grouped in the vector mₖ, where k=1, 2, . . . N. As an example, if the model is one-dimensional and one is only looking of the vertical resistivity profiles, ρᵢ, and the chargeability profiles, ηᵢ, then the vector m={mₖ} will take the form

$$m = [ \begin{matrix}{ρ}_{1} \\ {ρ}_{2} \\ {η}_{2} \\ {ρ}_{2} \\ {η}_{3} \\ ⋮\end{matrix} ] , \qquad ( 18 )$$

where the geo-electric parameters are indicated in FIG. 2, showing schematically a layered rock strata (layers 2-5) situated below sea (layer 1).

The inventive MOPS procedure is defined by identifying the data-parameters that are most sensitive to a given set of target geo-electric parameters mₖ, distributed over the various layers as shown in FIG. 2.

In the context of hydrocarbon detection by means of electromagnetic responses to either a controlled source or a natural source (like the electromagnetic fields originating in the ionosphere, or generated by lighting storms), we start from a set of measurements that may include potential differences u₀ᵢ, magnetic background field Bᵢ and/or concentrations of chemical species Cᵢ taken from sea bottom samples. The index i labels both times and locations/offsets from the source and may take the form i=j+nN_{T}, where j=0, . . . , N_{T}−1 labels N_{T} different discrete times (or frequencies, depending on whether the data is collected in the time- or frequency domain) and n=1, . . . , N₀ labels the different locations or offsets. If N_{T}=1, then i labels offset values only. By combining these variables into a vector

$$u = [ \begin{matrix}{u}_{0} \\ B \\ C\end{matrix} ] , \qquad ( 19 )$$

or simply u=u₀ if we are only considering E-field-data.

The data in the u vector will have been subject to normal processing steps so as to reduce unwanted drift and other noise contributions. For concreteness, assume u is just the normal potential differences measured along a sequence of towed electrodes trailing behind a transmitter. These differences may be normalized by their initial values so as to become dimensionless numbers. The data processing may also include standard procedures such as binning, band-pass filtering and stacking. In the following we will assume that the data has been subjected to at least one of these standard procedures and averaged into N_{B} spatial bins of size that match(es) the geological scales of interest (for instance, the signal may be averaged over 1 km blocks, see above), and positions xᵢ, which may be the distance from the start of a survey line, and discrete time bins of a size that corresponds to the desired resolution. The time then takes discrete values t. So the number of spatial bins along a data-line is N_{B}, and there are N_{T} different time values in each response after binning

We may define a new MOPS variable v being a function of the u vector, where each of these MOPS variable v(k,t) is designed to optimize the sensitivity to the particular geo-electric parameter mₖ. For example, each MOPS variable v(k,t) may be defined as

v(k,t)=e(k,t)·u(t) (20)

which is the projection of the data-vector u in the direction given by the unit vector e(k,t) (which may vary in time). In the final inversion of the EM data, several k-values will be used. In order to optimize sensitivity we are actually optimizing the signal to noise ratio, and we thus need to estimate the noise contributions. Noise measurements are therefore carried out as part of the data processing.

The noise may be measured as variations around the local average values obtained at each bin position xᵢ. Then the deviation

$$〈 δ {{v}^{′} ( k , t )}^{2} 〉 = \frac{1}{{N}_{B}} {\sum }_{i = 1}^{{N}_{B}} {( {v}^{i} ( k , t ) - \overline{v} ( k , t ) )}^{2} \qquad ( 21 )$$

where i is a pulse number and v̅(k,t) is the stacked average of the response at time t. The result is a measure of the uncertainty in v′(k,t). The above result may also be obtained by Fourier methods.

In addition to the above non-systematic uncertainty comes the uncertainty in v(k,t) itself which is caused by various systematic contributions such as uncertainties in tow depths, bathymetry and unknown 3D structures (for example horizontal contrasts in conductivity). In order to represent these systematic uncertainties, which are all proportional to the strength of the transmitter current, we may add a contribution Δ_{wd}v(k,t) to the above non-systematic uncertainty. This contribution may as a first approximation be taken as Δ_{wd}v(k,t)∝v(k,t). However, an even better estimate of the above-mentioned systematic uncertainty may be obtained by the equation

Δ_{wd}v(k,t)=v(k,h+Δh,t)−v(k,h,t) (22)

where h is a parameter that generates a systematic error, for example a water depth variation, and v(k,h,t) is the calculated field parameter based on a given h-value. Δh is the estimated uncertainty in h. The total uncertainty, i.e. from both non-systematic (Δv(k,t)) contributions and systematic (Δ_{wd}v(k,t)) contributions, may thus be estimated by

[symbol]

δv(k,t)² [symbol] = [symbol] δv′(k,t)² [symbol] +(Δ_{wd}(k,t))² (23)

Finally, the last input to the MOPS procedure is the calculation of the target response ∂(k,t)/∂mₖ, which may be calculated as a finite difference

$$\frac{\partial v ( k , t )}{\partial {m}_{k}} \approx \frac{v ( k , {m}_{k} + Δ {m}_{k} , t ) - v ( k , {m}_{k} , t )}{Δ {m}_{k}} \qquad ( 24 )$$

where v(k,mₖ,t) is a forward calculation based on an initial assumption of a geological model giving an initial data set{mₖ}, and Δmₖ is an increment of the particular mₖ-value.

In a preferred embodiment of the invention, the MOPS procedure identifies the most sensitive data-parameter by minimizing the function

$$ψ ( k , t ) = \frac{〈 δ {v ( k , t )}^{2} 〉 + {( {Δ}_{wd} ( t ) )}^{2}}{{( \partial v ( k , t ) / \partial {m}_{k} )}^{2}} \qquad ( 25 )$$

or, if the systematic contribution Δ_{wd}v(k,t) of the uncertainty is ignored

$$ψ ( k , t ) = \frac{〈 δ {v ( k , t )}^{2} 〉}{{( \partial v ( k , t ) / \partial {m}_{k} )}^{2}} , \qquad ( 26 )$$

with respect to the projection e(k,t) (equation 20). This particular embodiment of the MOPS procedure singles out the direction in u-space that has an optimized signal-to-noise ratio.

Case Example Focusing on Chargeability Over a Known Reservoir

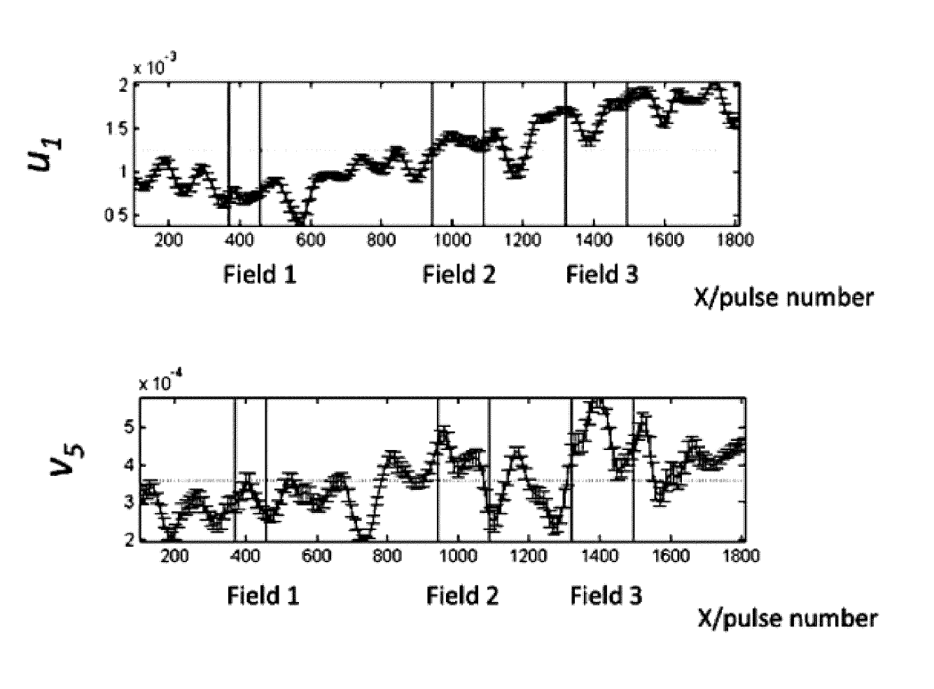

It is well known that η anomalies (i.e. anomalies in chargeability within the geological structure) are correlated with underlying hydrocarbon reservoirs. In this example we optimize ψ(k=5,t), which means focusing on the chargeability η₃. In this case η₃ represent the chargeability in a layer of 500 meters thickness located 200 meters below the sea bottom, and 1.5-2 kilometers above known hydrocarbon reservoirs. FIG. 3 shows the result of the measurements, both of the original potential differences u₁(t) and for the transformed variable v(k=5,t), at a time t about 1 second after a pulse shut-off. The locations of three known reservoirs (Field 1, Field 2 and Field 3) are indicated on the horizontal axis showing the positions along the survey lines. Normally, a full inversion with respect to Θ₃ would be required to see a correlation with the reservoir locations as these usually are not observable directly in the uᵢ values. However, the maxima of the transformed variable v(k=5,t) are seen to correlate well with the reservoir locations Field 1, Field 2 and Field 3. This implies that interpretation may be done directly in the processed data instead of, or in addition to, inversion (providing potentially ambiguous inversion results).

Inversion with MOPS Parameters

The operation of projecting out a single direction in u-space discards the information along the orthogonal components. This may be corrected for by carrying out the optimization for several k-values, systematically identifying the directions that optimize sensitivity for the different mₖ-values. Hence, the other directions in u-space will be represented.

The inversion is afterwards carried out by minimizing the objective function

ϕ=Σₖ₌1^{N″}ϕₖ(t) (27)

where N″<N′ and where the objective function ϕₖ at k includes the measured data v^{d}(k,t)

$${φ}_{k} = {\sum }_{t} \frac{{( {v}^{d} ( k , t ) - {v}^{m} ( k , t ) )}^{2}}{〈 δ {v ( k , t )}^{2} 〉} \qquad ( 28 )$$

where v^{m}(k,t) are the calculated values obtained from the model parameters m. The same minimization algorithm may be applied to obtain the most sensitive direction in u-space at incremental changes in mₖ, thus giving the e(k,t) vector (as in the actual inversion for the m-vector). In the above mentioned example (FIG. 3), which includes only e(k,t), the well known Levenberg-Marquart algorithm was used. Using N=N₀, the number of e(k,t) vectors is the same as the number of data-points. In other words, all the dimension of the data-space are accessed, except in the rare case where the set of e(k,t) vectors is linearly dependent.

Note that when mₖ is a parameter that has little impact on the data (for example a deep resistivity), it will have a corresponding weak effect in the objective function ϕₖ. The same is the case for t-values where the sensitivity is small.

This method differs from the linear methods of synthetic steering [3] and principal component analysis, most notably by virtue of being entirely non-linear. Standard transformations of the mₖ-values, such as m→log(m), may be applied for numeral reasons in order to reduce the dynamic range of the variables that the method inverts for.

Transmitter Pulse Optimization with the MOPS Method

The above steps are all steps that optimize the use and processing of acquired data. However, the MOPS parameters may also be used to optimize the pulse currents Iᵢ's during the progression of a survey. This may be done on the basis of on-board data inversion, since a preliminary geological model may be used to tune the currents Iᵢ so as to maximize ψₖ of equation (25) or (26). This is done by the same, or nearly the same, minimization algorithms as the one that finds the optimal e(k,t) directions and in the inversion process itself. Note that the recombination of currents allows a transition from a virtually vertical transmitter to a horizontal transmitter. Different targets k will favor different Iᵢ combinations. Hence, a possible outcome of the above described procedure is a survey having a number of separate current configurations.

In the preceding description, an aspect of the method and the apparatus according to the invention have been described with reference to an illustrative embodiment. For purposes of explanation, a method and apparatus were set forth in order to provide a thorough understanding of the invention and its workings. However, this description is not intended to be construed in a limiting sense. Various modifications and variations of the illustrative embodiment, as well as other embodiments of the method and apparatus, which are apparent to persons skilled in the art to which the disclosed subject matter pertains, are deemed to lie within the scope of the present invention.

### REFERENCES

[1]:Cole, K. and R. Cole, 1941, Dispersion and absorption in dielectrics: J. Chem. Phys., 9, 341-351.
[2]: Davydycheva, S., S. N. Rykhlinkski, and P. Legeydo, 2006, Electrical prospecting method for hydrocarbon search using the induced-polarization effect: Geophysics, 71, 179-189.
[3]: Fan, Y., R. Snieder, E. Slob, J. Hunziker, and J. Singer, 2011, Steering and focusing diffusive fields using synthetic aperture: EPL
[4]: Komarov, V., 1980, Geoelectric prospecting using the induced polarization method: Nedra, 390.
[5]: Kulikov, A. V., and Y. A. Shemyakin, 1978, Geoelectric prospecting using the phase method of induced polarization; Nedra, 160. (Moscow).
[6]: Legeido, P., M. M. Mandelybaum, I. Pesterev, and E. Ageenkov, 2006, Electromagnetic sounding method using a transient field spatial derivation on several separations: European Patent Application EP 1 876 473 A1.
[7]: Nazarenko, O., 1961, Device for offshore (marine) electro-surveying: Inventions Bulletin (Sov., Nr. 18, 1962), 150184, 751834/26-10.
[8]: Perez-Perez, A., L. Onofrio, M. Bosch, and E. Zapata, 2011, Association between magnetic susceptibilities and hydrocarbon deposits in barinas-apure basin, Venezuela: Geophys., 76, p. 35-41.
[9] Orozco, A. F., Kemna, A., Zimmermann, E., 2012, Data error quantification in spectral induced polarization imaging. Geophysics 77, p. 227-237
[10]: Schlumberger, C., 1920, Etude sur la prospection electrique du sous-sol: Gauthier-Villars.

1. A method of measuring and analyzing measurement data from an electromagnetic survey of a geological target area that potentially contains a hydrocarbon reservoir,
the method comprising the step of
A) measuring a measurement vector u between receiver electrodes, said measurement vector u comprising a plurality of measurement signals uᵢ, wherein
at least one of the plurality of measurement signals uᵢ is dependent on a geological characteristic mₖ at a geological parameter index k, where said geological characteristic mₖ provides information about the geological structure of the geological target area,
wherein the method further comprises the following step:
B) calculating a transformed vector v as a function of the measurement vector u. where each component v(k,t) of the transformed vector v at a geological parameter with index k and a time t is calculated by projecting the measurement vector u in the direction given by a unit vector e(k,t), said unit vector e(k,t) being governed by the geological characteristic mₖ,
said transformed vector v being designed to optimize the sensitivity to changes in the geological characteristic mₖ by performing, for each time t, at least one of
minimizing uncertainty δv(k,t) of the transformed vector v with respect to the geological characteristic mₖ,
where said uncertainty δv(k,t) comprises a non-systematic uncertainty δv′(k,t) and a systematic uncertainty Δ_{wd}v(k,t),
maximizing a target response ∂v(k,t)/∂mₖ of the transformed vector v with respect to the geological characteristic mₖ and
minimizing a ratio ψ(k,t) between at least the square of the non-systematic uncertainty <δv′(k,t)²> of the transformed vector v and the square of the target response (∂v(k,t)/∂mₖ)² of the transformed vector v with respect to the geological characteristic mₖ.

2. The method in accordance with claim 1, wherein minimizing the uncertainty δv(k,t) of the transformed vector v with respect to the geological characteristic mₖ is performed using an equation defined as
$$〈 δ v ( k , t ) 〉 = \sqrt{( 〈 δ {{v}^{′} ( k , t 〉}^{2} ) + {( {Δ}_{wd} v ( k , t ) )}^{2}} = \sqrt{\frac{1}{{N}_{B}} {\sum }_{i = 1}^{{N}_{B}} {( {v}^{i} ( k , t ) - \overline{v} ( k , t ) )}^{2} + {( v ( k , h + Δ h , t ) - v ( k , h , t ) )}^{2}} \qquad ( 29 )$$
where
N_{B} is the number of spatial bins along a measurement line, which spatial bin size corresponds to the geological scale of interest,
i is an integer number indexing each spatial bin,
vⁱ(k,t) is the value of the transformed vector v at spatial bin i, index k and time t,
v̅(k,t) is an average over a local spatial domain of the response at index k and time t,
h is a parameter that generates a systematic error in the transformed vector v, and
v(k,h,t) and v(k,h+Δh,t) are calculated components of the transformed vector v for the systematic errors h and h+Δh, respectively, at a geological parameter index k and a time t.

3. The method in accordance with claim 1 or 2, wherein maximizing the target response ∂v(k,t)/∂mₖ of the transformed vector v with respect to the geological characteristic mₖ is performed using an equation defined as
$$\frac{\partial v ( k , t )}{\partial {m}_{k}} \approx \frac{v ( k , {m}_{k} + Δ {m}_{k} , t ) - v ( k , {m}_{k} , t )}{Δ {m}_{k}} \qquad ( 30 )$$
where
Δmₖ is an increment of the geological characteristic mₖ and
v(k,mₖ,t) and v(k,mₖ+Δmₖ,t) are calculated components of the transformed vector v for the geological characteristics mₖ and mₖ+Δmₖ, respectively, at a given geological parameter index k and a time t.

4. The method in accordance with claim 1, wherein the optimization is carried out for a plurality of k values corresponding to a plurality of geological characteristics {mₖ}, thereby enabling a subsequent identification of at least one direction of the transformed vector v that optimize sensitivity for a corresponding geological characteristic mₖ.

5. The method in accordance with claim 4, wherein the method further comprises the step of minimizing an objective function defined as
$$φ = {\sum }_{k = 1}^{{N}^{″}} ( {\sum }_{t} \frac{{( {v}^{d} ( k , t ) - {v}^{m} ( k , t ) )}^{2}}{{( δ v ( k , t ) )}^{2}} ) \qquad ( 31 )$$

6. where
N″ is the total number of geological characteristics {mₖ} corresponding to said plurality of k values,
v^{d}(k,t) is a value of the transformed vector v corresponding to the measurement signal uᵢ at geological parameter index k and time t,
v^{m}(k,t) is a calculated value of the transformed vector v based on a geological characteristic mₖ corresponding to a predetermined model.

7. The method in accordance with claim 1, wherein the method further comprises the step of measuring locations of said receiver electrodes.

8. The method in accordance with claim 6, wherein the step A and the step of measuring locations of said receiver electrodes are performed simultaneously, or near simultaneously.

9. The method in accordance with claim 1, characterized in that at least one of measurement signals uᵢ is a potential difference.

10. The method in accordance with claim 1, wherein the geological characteristic mₖ is a geo-electric characteristic.

11. An apparatus for measuring and analyzing electromagnetic data over a geological target area that potentially contains a hydrocarbon reservoir, wherein the apparatus comprises at least two receiver electrodes suitable for recording measurement signals uᵢ from the geological target area and a computer program product stored on a computer usable medium comprising computer readable program means to control an execution of the method in accordance with any one of claims 1-9.

12. The apparatus in accordance with claim 10, wherein the apparatus further comprises a towing system comprising a plurality of lowing cables, where at least one towing cable comprises said at least two receiver electrodes and at least one towing cable comprises a plurality of transmitter (TX) electrodes, the transmitter (TX) electrodes being configured to broadcast electromagnetic signals to the geological target.

13. The apparatus in accordance with claim 11, wherein the plurality of transmitter (TX) electrodes are configured to broadcast electromagnetic signals in form of a plurality of current pulses with finite durations, and the at least one receiver electrode pair is configured to record the measurement signals uᵢ at points in time between the transmitted plurality of current pulses.

14. The apparatus in accordance with claim 11 or 12, wherein least one of
the position of the plurality of transmitter (TX) electrodes and
the transmitted current pulses from the plurality of transmitter (TX) electrodes is, by use of the computer program product, adjusted iteratively during the recording of the measurement signals uᵢ in order to optimize sensitivity to at least one geological characteristic mₖ of a given geological target.

15. The apparatus in accordance with claim 10, wherein the at least two receiver electrodes are arranged on a buoyant object.
